(19) United States
(12) Patent Application Publication
(10) Pub. No.: US 2006/0143626 A1
(43) Pub. Date: Jun. 29, 2006

(54) Positioning mechanism of slot-in optical disk drive

(76) Inventor: Heng-Min Hu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/048,941

(22) Filed: Feb. 3, 2005

(30) Foreign Application Priority Data
Dec. 28, 2004 (TW) 093221048

(51) Int. Cl. G11B 17/04

(52) U.S. Cl. 720/619

(57) ABSTRACT

A positioning mechanism of a slot-in optical disk drive includes a base chassis, a driving mechanism, a sliding member, a sliding plate and a push rod. The base chassis is used for disposition of the driving mechanism, the sliding member and the push rod. When an optical disk enters the disk drive, the optical disk pushes the push rod to rotate so as to activate the driving mechanism for driving the sliding member to move. The rotation angle of the push rod depends on the diameters of optical disks. A sliding post of the push rod slides inside a first locating slot or a second locating slot on the sliding plate so as to guide the push rod to drive optical disks with different diameters into the position of rotation for retrieving data therein.

### BACKGROUND OF THE INVENTION

The present invention relates to an optical disk drive, especially to a positioning mechanism of a slot-in optical disk drive that reads data from optical disks with different sizes so as to enhance the function of optical disk drives.

Nowadays we are facing the information explosion problem, and having concerns on information storage media. Optical disk is one of the most economic and convenient storage medias with advantages of large capacity, convenient portability, and resistance to damage. Due to the popularity of optical disk, optical disk drive has become one of the essential equipments on personal computers. In earlier days, tray-loading type optical disk drive is mainstream. When users want to retrieve data from the disc, an optical disk is placed on a tray. Then the tray is moved inside the optical disk drive for being read by a pick-up head. In usage, conventional tray-loading type optical disk drive is time consuming due to the movement of the tray. Moreover, users may get damage while unloading the optical disk without pressing the control button but running into the tray accidentally or the tray may even get deformed or broken.

Thus a slot-in optical disk drive is invented in order to improve above shortcomings. When being used, users just need to place the optical disk into the loading slot of the disk drive. Then the disk drive automatically loads the optical disk drive and reads the data therefrom. It's convenient and time-saving. However, the diameter of optical disks includes two types—12 cm and 8 cm. The slot-loading type optical disk available now can only read the 12 cm diameter optical disk. There is a limitation in the application of the optical disk drive.

Thus there is a need to provide a positioning mechanism of a slot-in optical disk drive that reads optical disks with two different sizes in order to solve above disadvantages.

### SUMMARY OF THE INVENTION

Therefore it is a primary object of the present invention to provide a positioning mechanism of a slot-in optical disk drive that positions the optical disk with different diameters so as to make the central hole of the disk corresponds to the turn table for being set on the turn table and rotated. Thus the data inside the disk is retrieved.

A positioning mechanism of a slot-in optical disk drive in accordance with the present invention includes a base chassis with a sliding member, a driving mechanism and a push rod. When the disk is pushed into the disk drive, the driving mechanism drives the sliding member to move upwards so as to make the push rod push the optical disk into the position of rotation. A sliding plate with a first locating slot and a second locating slot is arranged on the lower part of the sliding member. A sliding post is disposed on the push rod for inserting through the first locating slot and a second locating slot. When the optical disk enters the disk drive, it pushes the push rod. While the sliding member moves, disks with different diameters touches the push rod to rotate at different angles so as to guide the sliding post slides inside the first locating slot or a second locating slot. Thus the push rod pushes the disks with different diameters into the position of rotation.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembling view of the present invention;

FIG. 2A-FIG. 2G is a schematic drawing showing an 8 cm diameter disk being loaded into an optical disk drive in accordance with the present invention;

FIG. 3A-FIG. 3C is a schematic drawing showing an 8 cm diameter disk leaning towards one side and being loaded into an optical disk drive in accordance with the present invention;

FIG. 4A-FIG. 4C is a schematic drawing showing an 8 cm diameter disk leaning towards the other side and being loaded into an optical disk drive in accordance with the present invention;

FIG. 5A-FIG. 5G is a schematic drawing showing an 12 cm diameter disk being loaded into an optical disk drive in accordance with the present invention.

### DETAILED DESCRIPTION OF THE PREFFERED EMBODIMENT

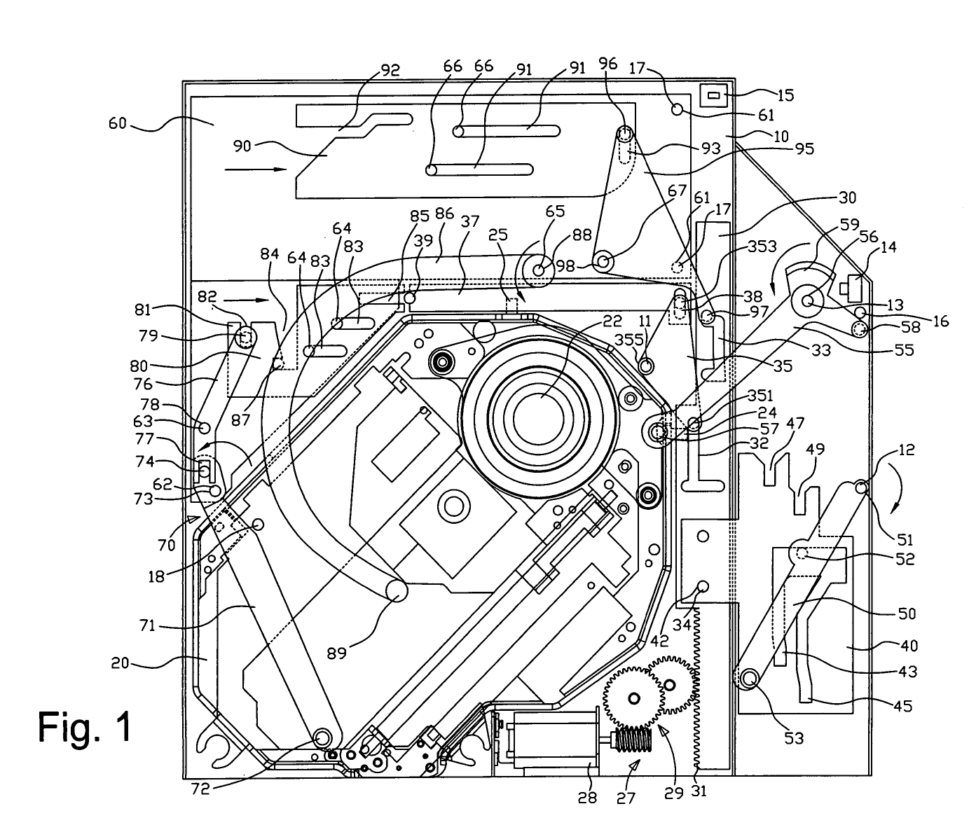

Refer to FIG. 1, an optical disk drive in accordance with the present invention includes a base chassis 10, a traverse 20 having a turn table 22 for loading optical disks and rotating disks to retrieve data. Two lift arms 24, 25 are disposed on two sides of the front end of the traverse 20 respectively. A driving mechanism 27 having a motor 28 and a gear set 29 is arranged on the bottom of the base chassis 10. The motor 28 drives the gear set 29 that further drives a sliding member 30 on the base chassis 10 to move upwards and downwards. By the combination of gear set 29 with a gear rack 31 on lateral side of the bottom of the sliding member 30, the sliding member 30 is driven. A lift slot with slope is disposed on lateral side of the top of the sliding member 30 for being inserted by the lift arm 24 of the traverse 20. The lift arm 24 is moveable inside the lift slot so that the lift slot guides the lift arm 24 moving upwards when the sliding member 30 moves upwards.

Moreover, the sliding member 30 further having a first sliding slot 32 and a second sliding slot 33. A sliding post 351 set on one end of a first ejector plate 35 inserts into the first sliding slot 32 while an insertion post 353 set on the other end of the first ejector plate 35 inserts into a straight slot 38 on a transverse-moving member 37. By a projective post 11 of the base chassis 10 inserting through an insertion hole 355 on the first ejector plate 35, the first ejector plate 35 is disposed on the base chassis 10. The transverse-moving member 37 is also arranged on the base chassis 10, placed at the lateral side of the top of the sliding member 30. A lift slot with slope is disposed on lateral side of the transverse-moving member 37 and the lift arm 25 of the traverse 20 inserts and slides inside the lift slot.

When the optical disk enters the optical disk drive and the sliding member 30 moves upwards, not only the lift arm 24 of the traverse 20 moves upwards, but also the first ejector plate 35 rotates in counterclockwise direction by the guiding of the first sliding slot 32 so as to push the transverse-moving member 37 moving away from the sliding member 30. The lift arm 25 inside the lift slot of the transverse-moving member 37 is driven to move upwards so that the traverse 20 moves upwards and the turn table 22 of the traverse 20 loads the positioned optical disk. When unloading the optical disk, the motor 28 rotates in reverse direction so that the sliding member 30 moves downwards. The transverse-moving member 37 moves towards the sliding member 30 and the lift arms 24, 25 move downwards relatively. Thus the traverse 20 is driven to move downwards to unload and eject the optical disk.

A plurality of fixing hole 42 is disposed on a sliding plate 40. By a plurality of fixing post 34 on lower part of the sliding member 30 inserting through the fixing hole 42, the sliding plate 40 is fixed on the lower part of the sliding member 30. A first locating slot 43 and a second locating slot 45 are mounted on the sliding plate 40, being in connection with each other. Moreover, a third locating slot 47 and a fourth locating slot 49 are further set on top of the sliding plate 40. The first locating slot 43 and the second locating slot 45 are used to guide a push rod 50 to position optical disks with different sizes.

An insertion hole 51 arranged on one end of the push rod 50 is inserted by a projective pillar 12 of the base chassis 10 so as to dispose the push rod 50 on the base chassis 10. A sliding post 52 is arranged on the push rod 50 for inserting through the first locating slot 43 and the second locating slot 45 so as to guide the push rod 50 to position the optical disks with diameter of 12 cm or 8 cm. An elastic component is hooked on the push rod 50 for applying an elastic force in clockwise direction on the push rod 50 so that the push rod 50 rotates in clockwise direction. Thus a push post 53 installed on the other end of the push rod 50 pushes the optical disk into the position of rotation inside the optical disk drive.

A pressed rod 55 with an insertion hole 56 on one end is disposed on the base chassis 10, placed over top of the sliding plate 40. By a projective post 13 of the base chassis 10 inserting through the insertion hole 56 of the pressed rod 55, the pressed rod 55 is arranged on the base chassis 10. An elastic component is hooked on the pressed rod 55 for applying an elastic force in counterclockwise direction on the pressed rod 55. Thus a push post 57 set on the pressed rod 55 places against the top of the optical disk while the disk enters the disk drive. The push rod 50 pushes the optical disk to the position of rotation. While the push rod 50 pushes the optical disk, the pressed rod 55 is also pushed by the push rod 50 to rotate in clockwise direction. The rotation angle of the pressed rod 55 depends on the size of the optical disk. When the push rod 50 pushes the optical disk to the position of rotation, the pressed rod 55 also rotates for positioning. If the diameter of the disk is 12 cm, a positioning post 58 arranged on one end of the pressed rod 55 is mounted on the third locating slot 47 of the sliding plate 40 so as to make the push post 57 on the pressed rod 55 leaves the optical disk without contacting. Thus the optical disk won't be scratched when the turn table 22 rotates the disk. In similar way, if the diameter of the disk is 8 cm, the positioning post 58 is mounted on the fourth locating slot 49 of the sliding plate 40.

Furthermore, when the pressed rod 55 rotates, a starting block 59 on the pressed rod 55 contacts a starting switch 14 to activate the motor 28 of the driving mechanism 27 so as to make the sliding member 30 move upwards. Then the motor 28 stops working when the sliding member 30 contacts a stop switch 15 on top of the base chassis 10. When the disk is unloaded from the disk drive, the pressed rod 55 being applied by an elastic force in counterclockwise direction rotates in counterclockwise direction to make the push post 57 push the optical disk out of the disk drive. A positioning pin 16 is set on the base chassis 10 for positioning the pressed rod 55.

A guiding mechanism is used to guide the optical disk when the push rod 50 pushes the optical disk into the position of rotation. The guiding mechanism composed by a linkage mechanism 70, a fixing board 80 and a guiding arm 86 is disposed on a base board 60, located at the position corresponding to the sliding member 30. The guiding mechanism can also be directly arranged on the base chassis 10. The base board 60 is fixed on the base chassis 10 by a projective post 17 inserting through an insertion hole 61. The linkage mechanism 70 includes a first link 71 and a second link 76. A push post 72 is installed on one end of the first link 71 while an insertion hole 73 and a connecting post 74 are disposed on the other end thereof. The insertion hole 73 is inserted by a projective post 62 on the base board 60 so as to arrange the first link 71 on the base board 60.

In addition, by the connecting post 74 mounting inside a connecting slot 77 on one end of the second link 76, the first link 71 is connected with the second link 76. The second link 76 is arranged on the base board 60 through an insertion hole 78 being inserted by an projective post 63 on the base board 60. A mounting post 79 arranged on the other end of the second link 76 is mounted inside a mounting slot 82 on a lock plate 81 of the fixing board 80 so that the fixing board 80 is driven by the movement of the linkage mechanism 70.

A plurality of transverse slot 83 is disposed on the fixing board 80. A plurality of transverse-moving post 64 arranged on the base board 60 insert into the transverse slot 83 respectively so as to make the fixing board 80 move transversely over the base board 60. The fixing board 80 further having a hook slot 84 for being hooked by a guiding post 87 on the guiding arm 86 so as to position the guiding arm 86. Moreover, a separative slot 85 is arranged on the fixing board 80, corresponding to the transverse-moving member 37. When the disk load into the drive, the transverse-moving member 37 moves towards the fixing board 80 and pushes the fixing board 80 by a separative post 39 on the transverse-moving member 37 matching with the separative slot 85.

By an insertion hole 88 disposed on one end thereof being inserted with a projective post 65, the guiding arm 86 is arranged on the base board 60 and a push post 89 is installed on the other end of the guiding arm 86. An elastic component is hooked on the guiding arm 86 for applying an elastic force in counterclockwise direction on the guiding arm 86 so that the push post 89 can press against the disk when it enters the disk drive and then the push rod 50 can push the disk to the position of rotation. Furthermore, when the disk is ejected from the disk drive, the push post 89 pushes the disk out of the drive. In order to position the original location of the guiding arm 86, the first link 71 of the linkage mechanism 70 is hooked with an elastic component for applying an elastic force in counterclockwise direction on the first link 71 so as to make the first link 71 rotate in counterclockwise direction and drive the second link 76 to rotate in clockwise direction. Thus a rightward force is applied on the fixing board 80, as shown in figure, so as to make the lock plate 81 hook with the guiding post 87 on the guiding arm 86 for positioning the guiding arm 86. In addition, a positioning pin 18 is disposed on the base chassis 10 for positioning the first link 71.

A plurality of transverse slot 91 is disposed on a stop plate 90, in combination with a plurality of transverse-moving post 66 on the base board 60, the stop plate 90 is arranged on the base board 60. A guiding post 87 on the guiding arm 86 is used to insert into a stop slot 92 disposed on the stop plate 90. The disk pushes the guiding arm 86 to move upwards when the disk with diameter of 12 cm is loaded into the disk drive and then the guiding post 87 slides inside the stop slot 92 so as to guide the disk to the position of rotation. The stop plate 90 further having a straight slot 93 for being inserted by a push post 96 on one end of a second ejector plate 95 while a sliding post 97 on the other end of the second ejector plate 95 inserts into the second sliding slot 33 on the sliding member 30, Thus when the sliding member 30 moves upwards or downwards, the second ejector plate 95 is pushed by the second sliding slot 33 so as to position the guiding arm 86. The second ejector plate 95 is set on the base board 60 by a projective post 67 on the base board 60 inserting through an insertion hole 98 mounted on the second ejector plate 95.

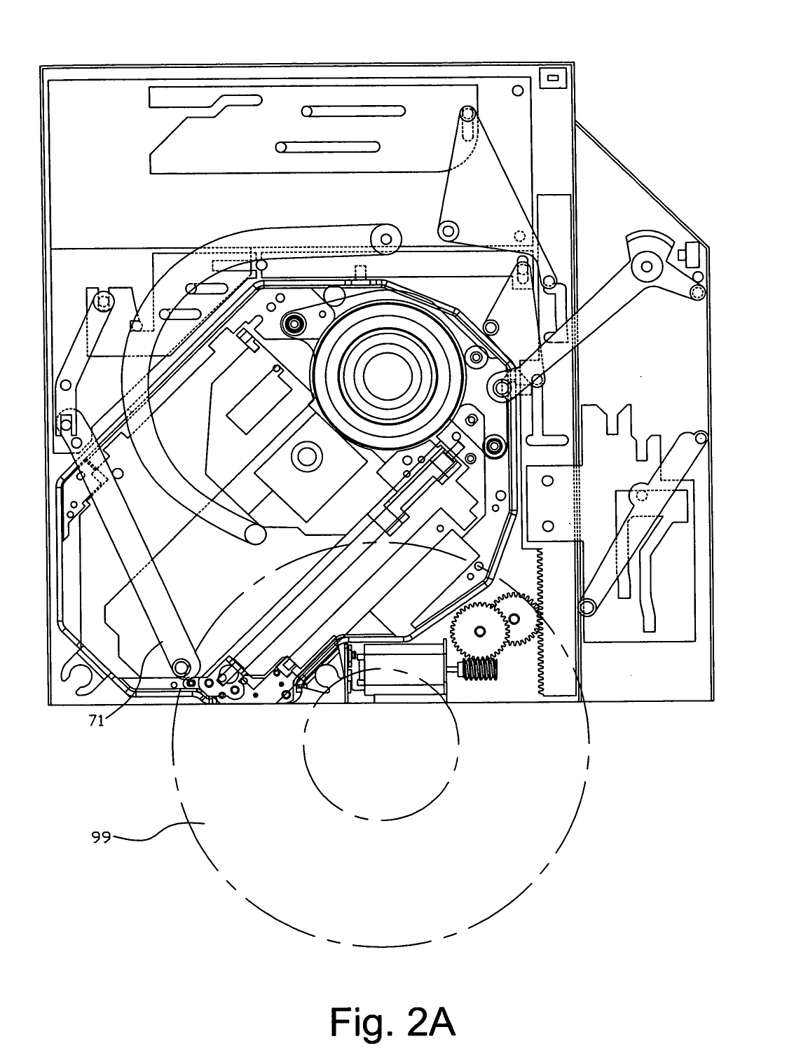

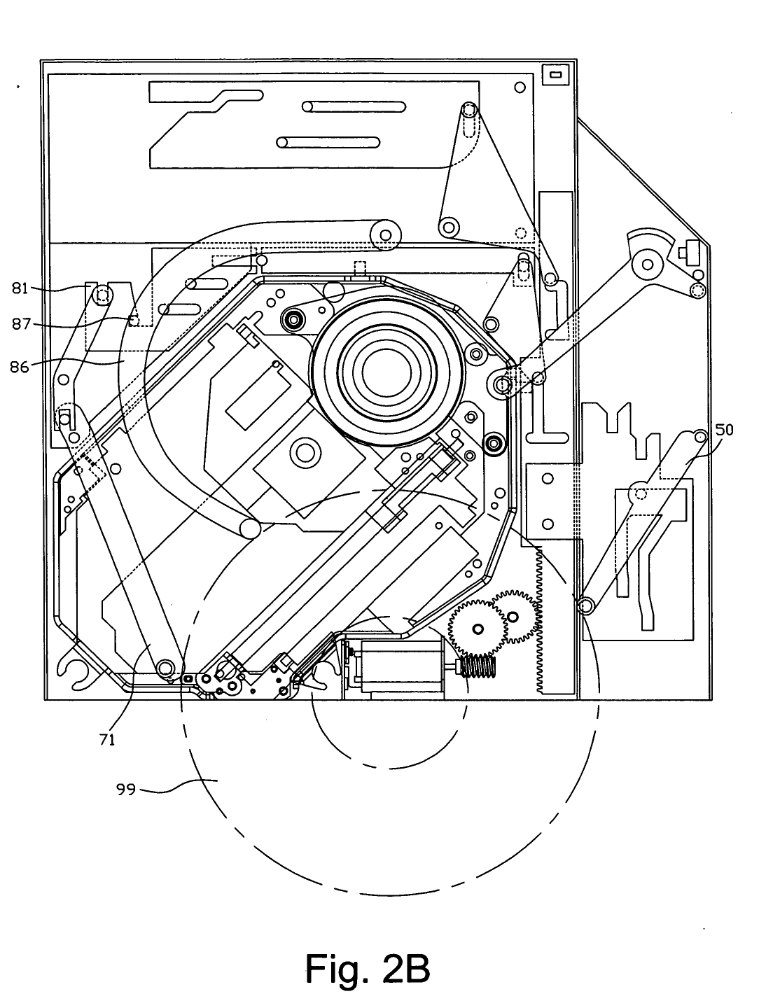

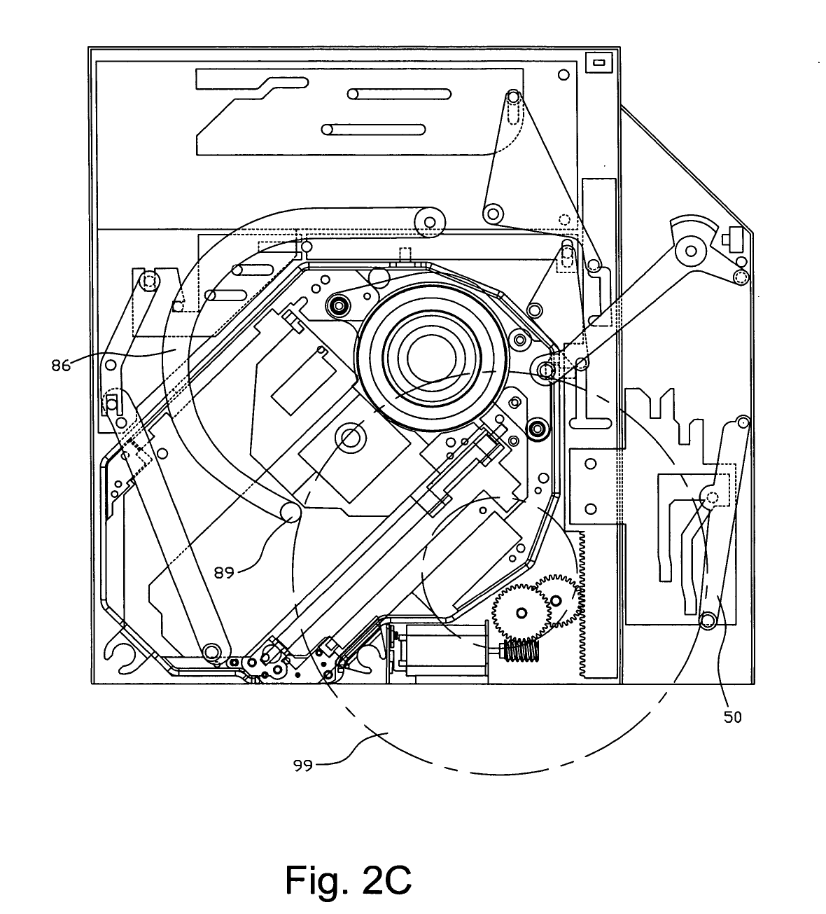

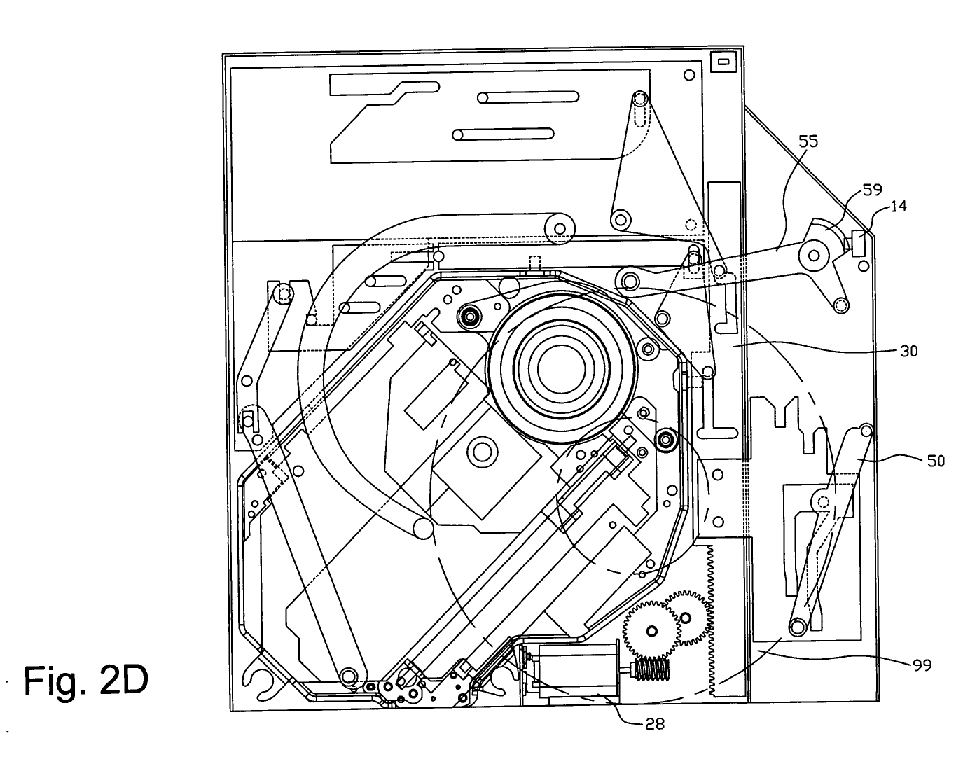

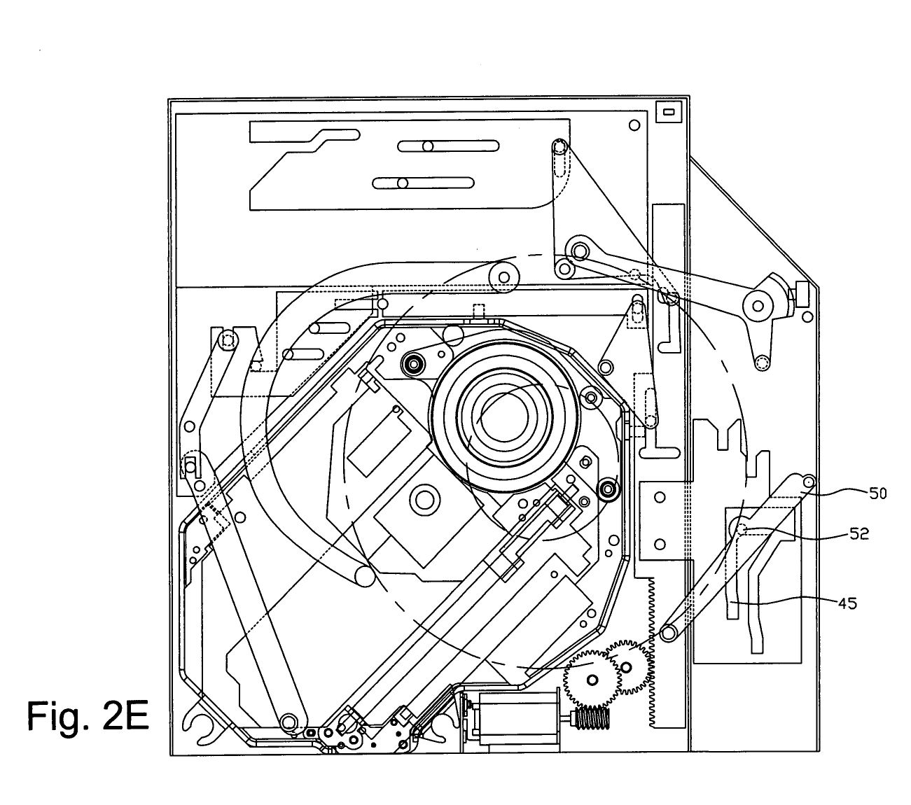

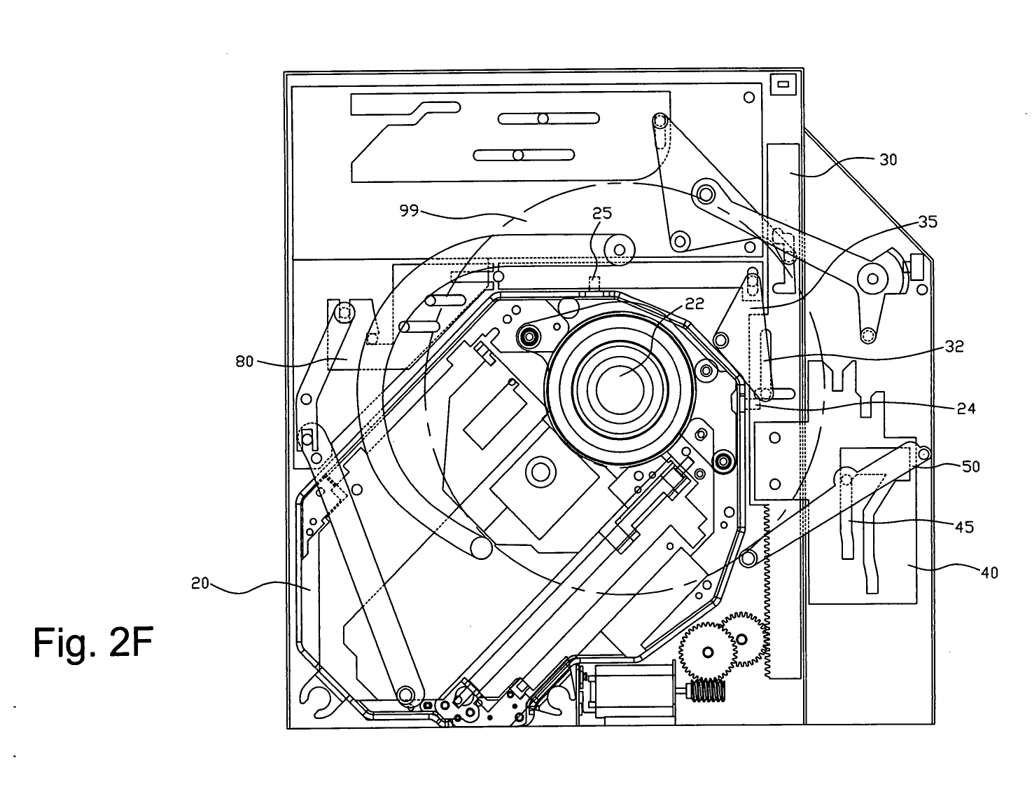

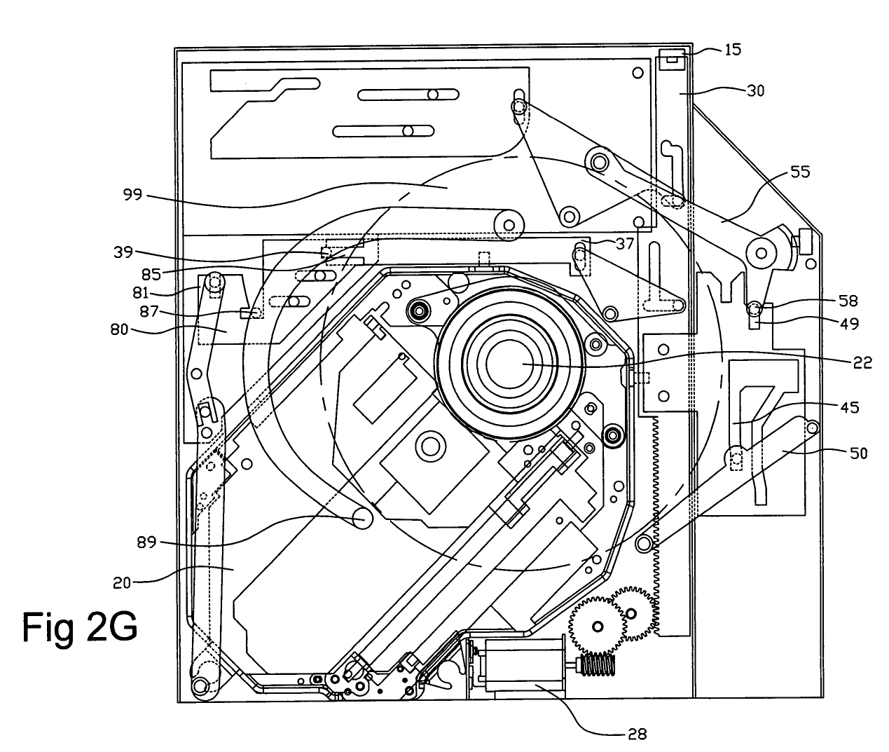

Refer from FIG. 2A to FIG. 2G, a schematic drawing showing a 8 cm diameter disk being loaded into an optical disk drive in accordance with the present invention is disclosed. As shown in FIG. 2A, users pushes a 8 cm diameter optical disk 99 into the optical disk drive, and the first link 71 is pushed and rotated. The optical disk 99 keeps moving in, refer to FIG. 2B, the optical disk 99 stops pushing the first link 71 due to the small diameter of the optical disk 99 and then further pushes the push rod 50 and the guiding arm 86. Because the guiding post 87 of the guiding arm 86 hooks with the lock plate 81, the guiding arm 86 doesn't move, as shown in FIG. 2C. Thus the optical disk 99 moves towards the push rod 50. The push post 89 on the guiding arm 86 keeps contacting with the optical disk 99 during the loading process of the optical disk 99 as a guiding point.

Later, the optical disk 99 keeps moving into the disk drive, as shown in FIG. 2D, the optical disk 99 pushes the pressed rod 55 to rotate so that the starting block 59 on the pressed rod 55 contacts a starting switch 14 to activate the motor 28 for making the sliding member 30 moving upwards. Then the push rod 50 pushes the optical disk 99 into the disk drive. Refer to FIG. 2E, the sliding post 52 of the push rod 50 slides into the second locating slot 45. And then, refer to FIG. 2F, the sliding plate 40 moves upwards along with the sliding member 30 and the second locating slot 45 guides the push rod 50 to rotate so as to push the optical disk 99 into the position of rotation. When the sliding member 30 moves upwards, the lift arm 24 is also moving upwards and the first sliding slot 32 guides the first ejector plate 35 moving toward the fixing board 80 so as to make the lift arm 25 move upwards. By the upward movement of the lift arms 24, 25, the traverse 20 is driven to move upwards. Thus the positioned disk 99 is set on the turn table 22 of the traverse 20.

Finally, as shown in FIG. 2G, the sliding member 30 contacts the stop switch 15 so that the motor 28 stops working and the sliding member 30 is positioned. Now the separative post 39 of the transverse-moving member 37 slides into the separative slot 85 of the fixing board 80 so as to make the fixing board 80 move. Thus the guiding post 87 moves out of the lock plate 81 and the guiding arm 86 rotates a bit upwards so as to make the push post 89 on the guiding arm 86 leave the optical disk 99. The positioning post 58 of the pressed rod 55 is mounted on the fourth locating slot 49 so that the pressed rod 55 leaves the optical disk 99 without contacting. The push rod 50 also leaves the optical disk 99 due to the guidance of the second locating slot 45. Therefore, the optical disk 99 won't be scratched while being rotated by the turn table 22.

After being used, the optical disk 99 is unloaded by pressing the unload button of the disk drive. The motor 28 is activated and rotates reversely so as to make the sliding member 30 move downwards. Now the disk drive works in a reverse way of the loading process of the optical disk 99. The turn table 22 of the traverse 20 moves downwards and unmounts the optical disk 99. Then the pressed rod 55 pushes the optical disk 99 out of the disk drive.

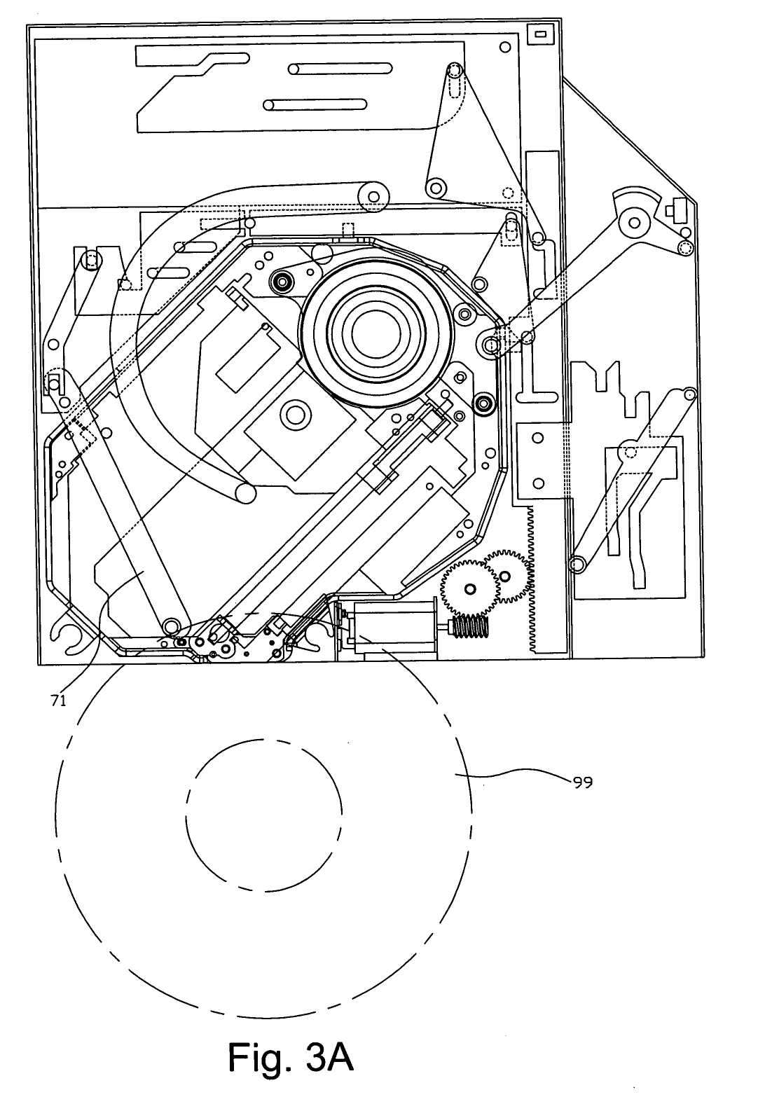

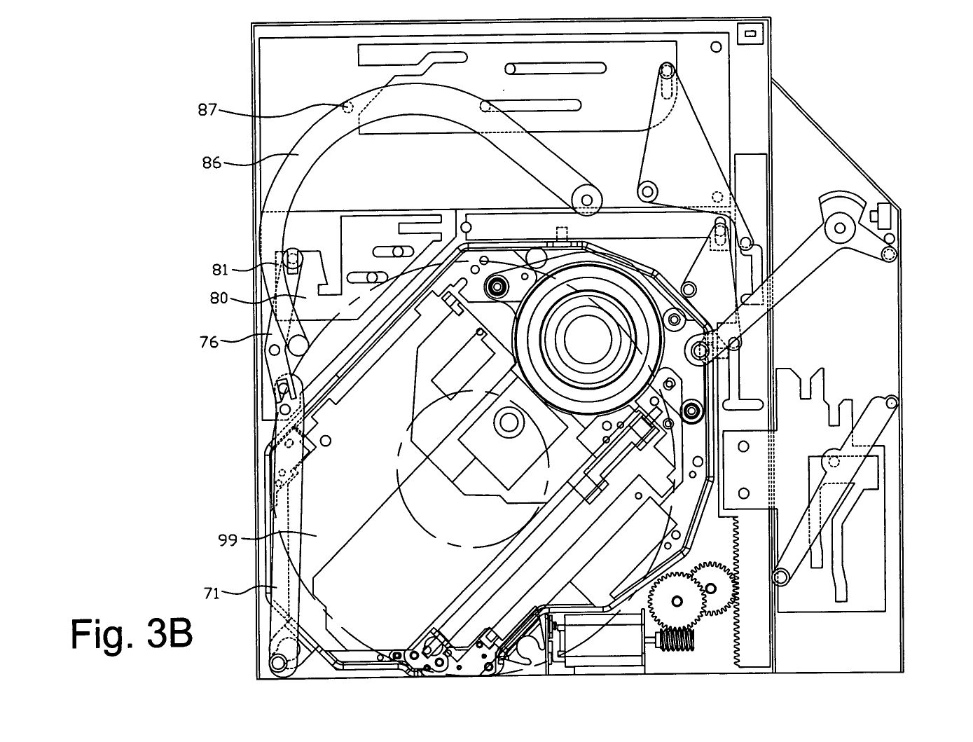

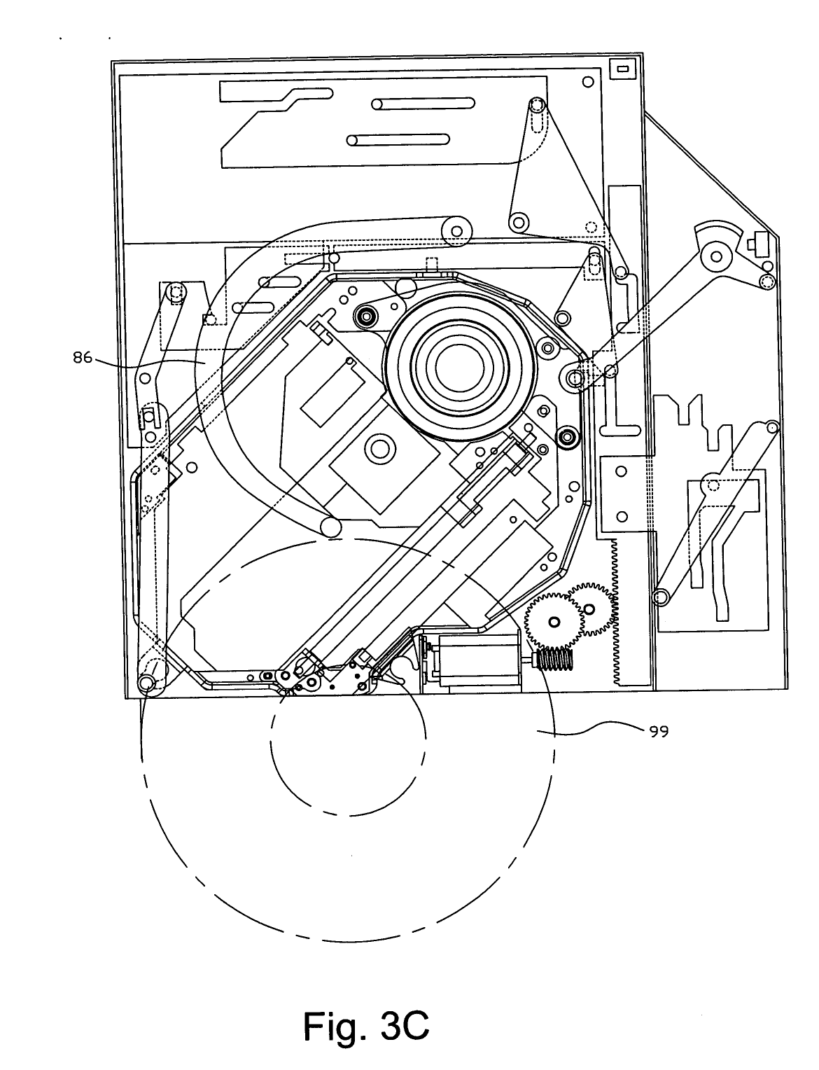

Refer to FIG. 3A, when users push the optical disk 99 with diameter of 8 cm into the optical disk drive and the optical disk 99 is toward the first link 71, users keep pushing the optical disk 99, as shown in FIG. 3B, then the optical disk 99 pushes the first link 71 to rotate so that the second link 76 drives the fixing board 80 to move. Thus the guiding post 87 of the guiding arm 86 moves out of the lock plate 81. When users push the optical disk 99, the optical disk 99 also pushes the guiding arm 86 to move. However, due to the elastic component hooked thereon, the guiding arm 86 is applied with an elastic force in a counterclockwise direction. Thus the guiding arm 86 pushes the optical disk 99 out of the disk drive, as shown in FIG. 3C.

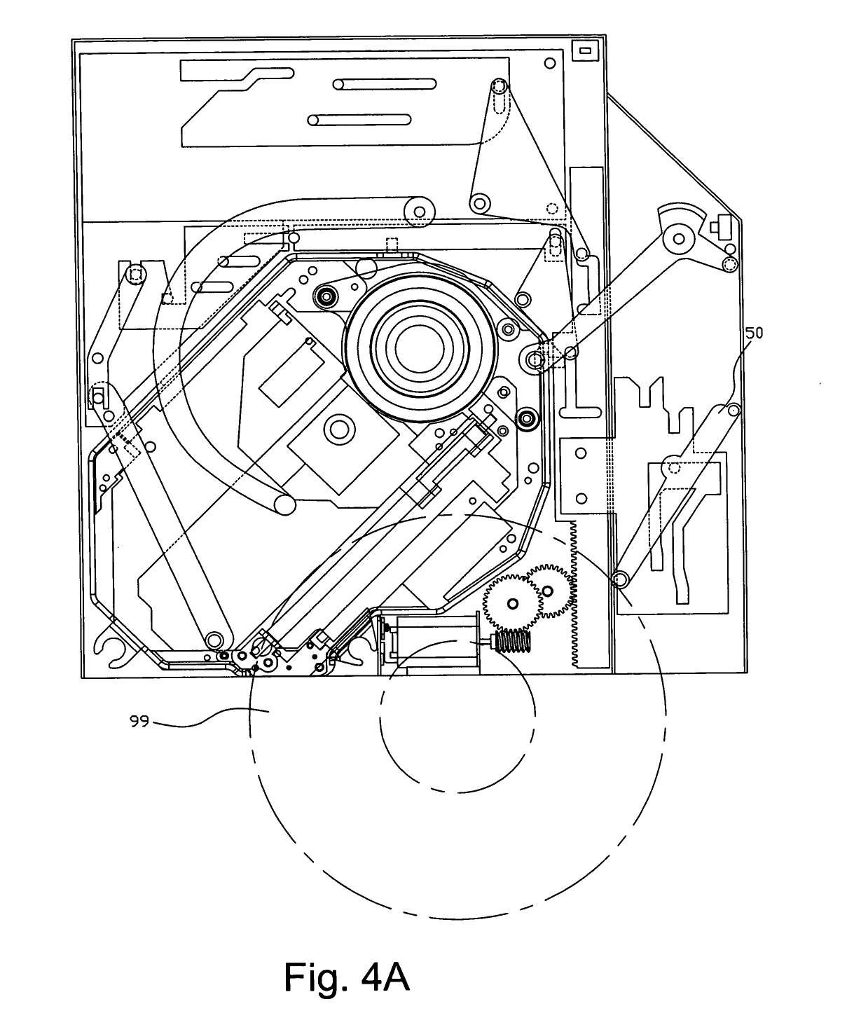

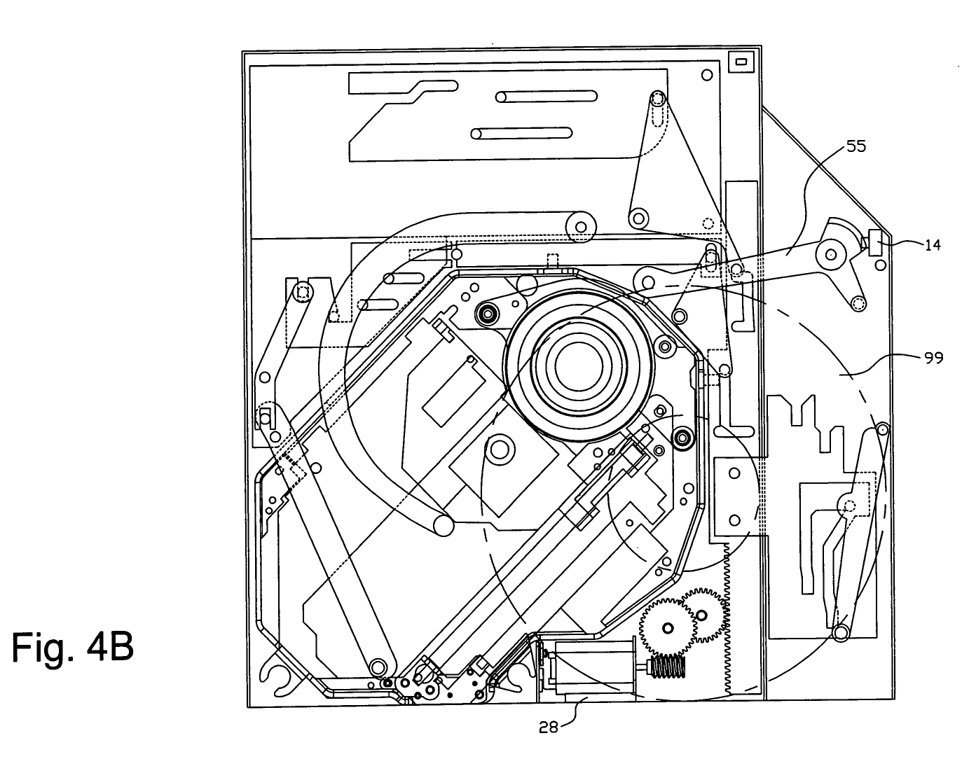

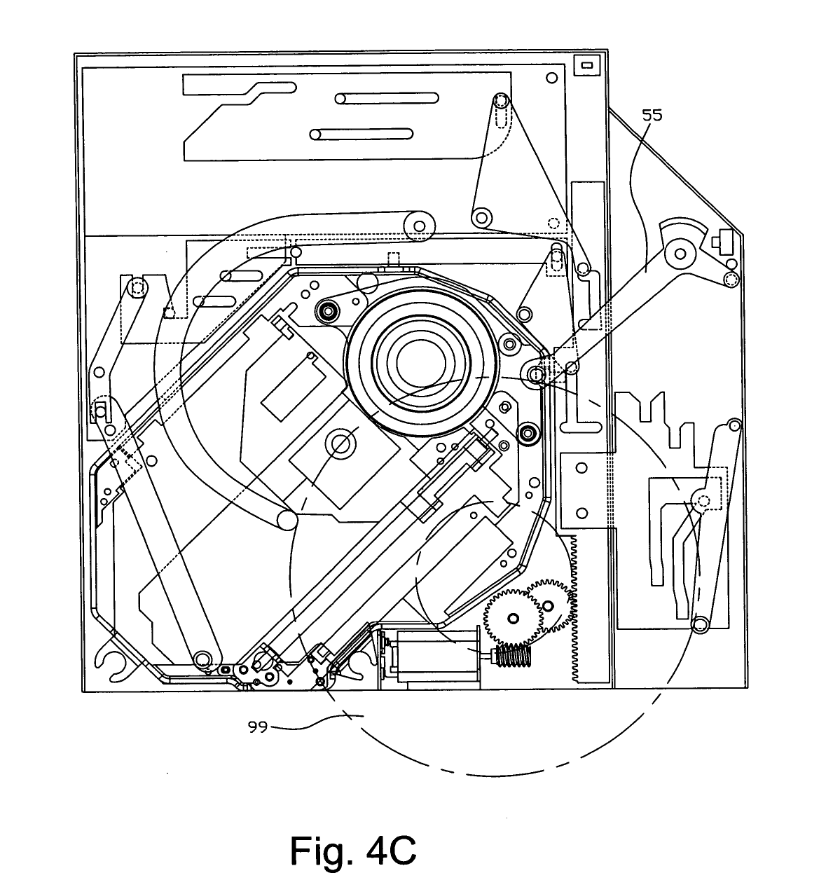

Refer to FIG. 4A, when users load the optical disk 99 with diameter of 8cm into the optical disk drive and the optical disk 99 leans on the push rod 50, users keep pushing the optical disk 99, as shown in FIG. 4B, then the optical disk 99 pushes the pressed rod 55 to rotate. However, the pressed rod 55 is applied with an elastic force in counterclockwise direction by the hooked elastic component, thus as shown in FIG. 4C, the pressed rod 55 will make the optical disk 99 out of the disk drive. Moreover, as shown in FIG. 4B, the pressed rod 55 contacts the starting switch 14. In design of the present invention, the pressed rod 55 must keep touching the starting switch 14 after a period of time, the motor 28 will be activated. Thus such kind of brief contact will not activate the motor 28.

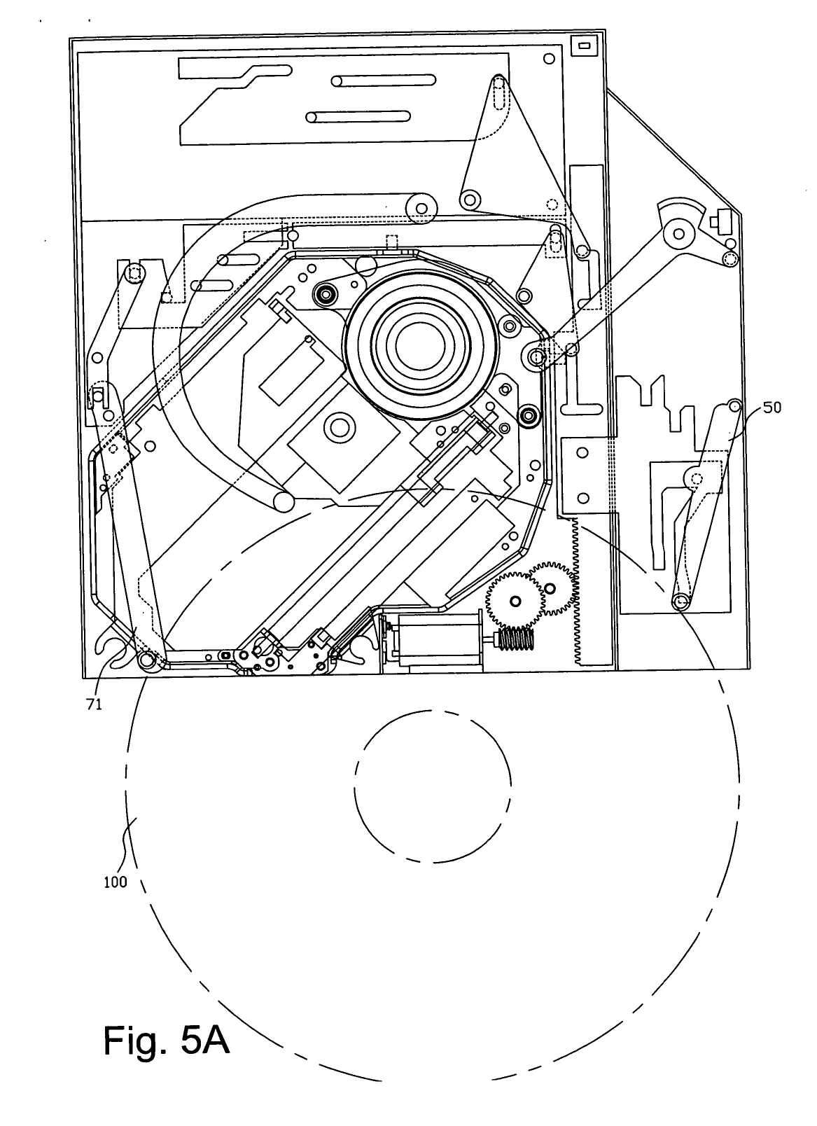

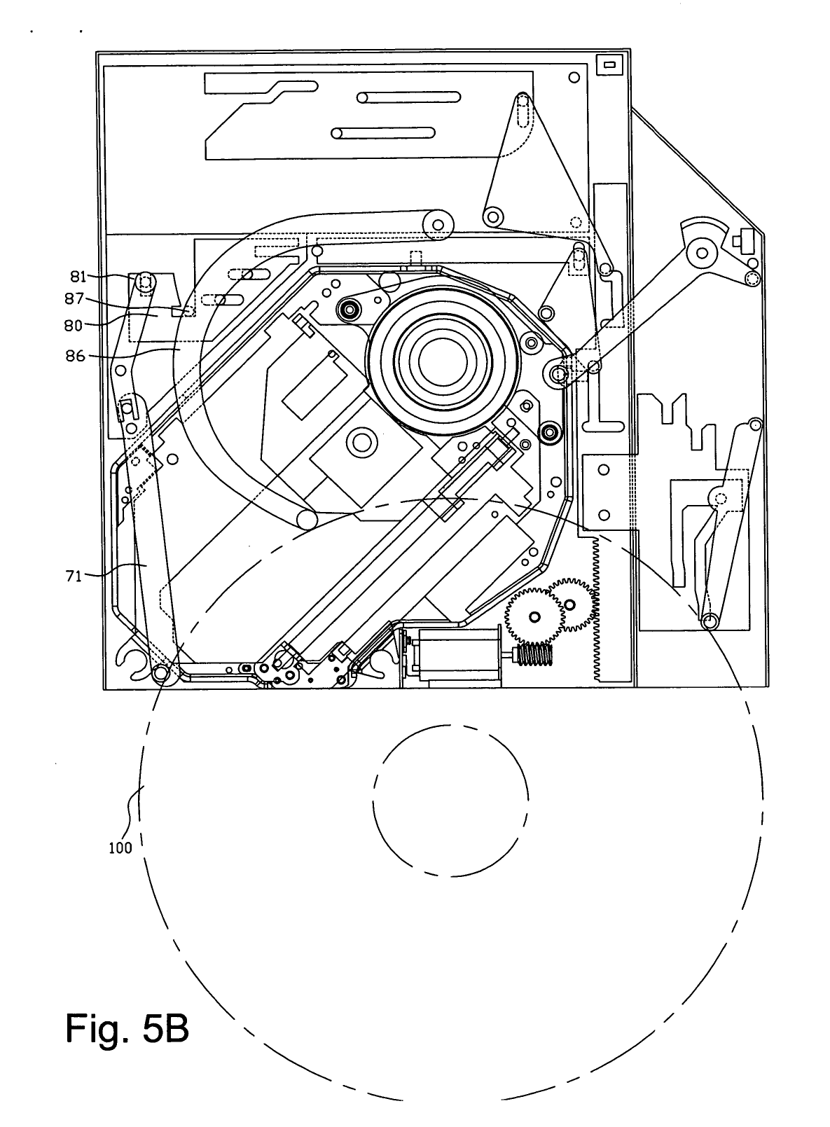

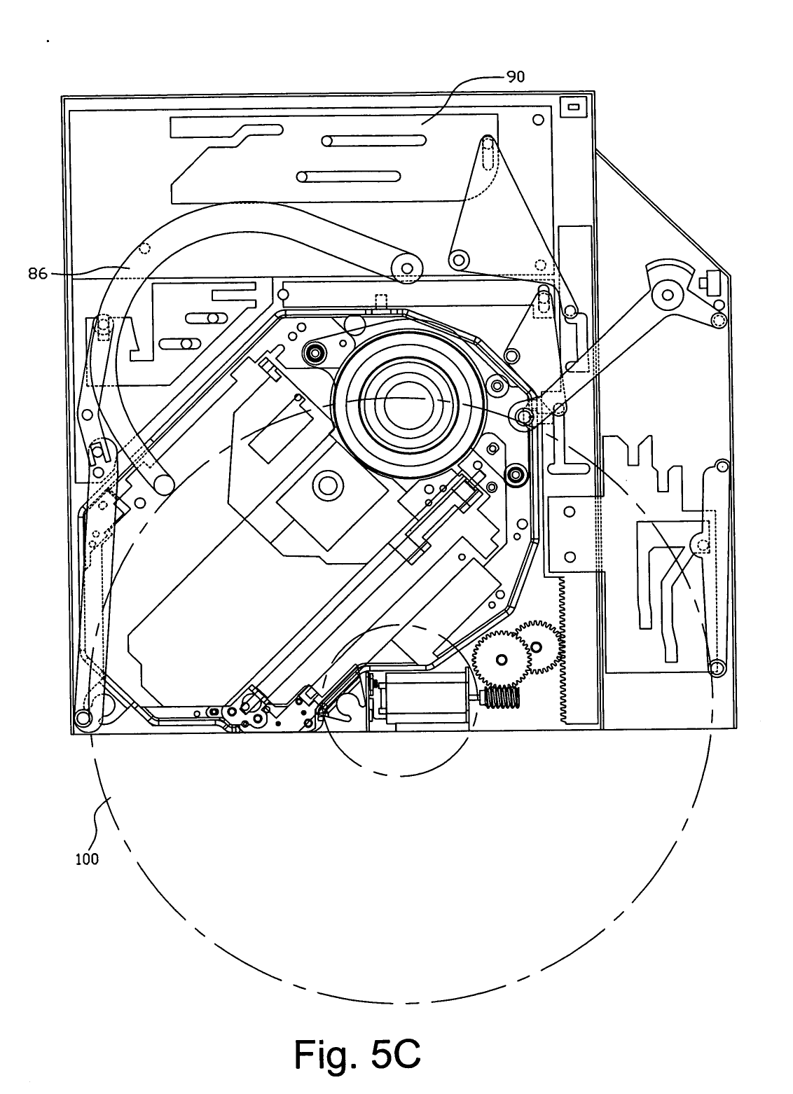

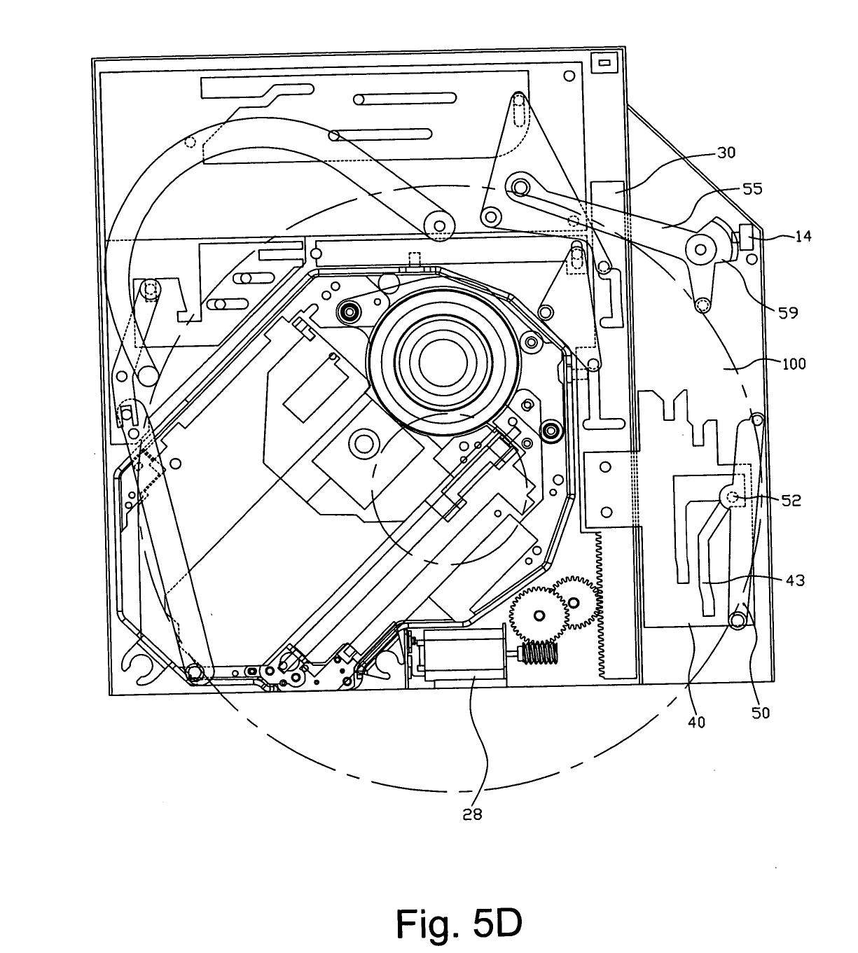

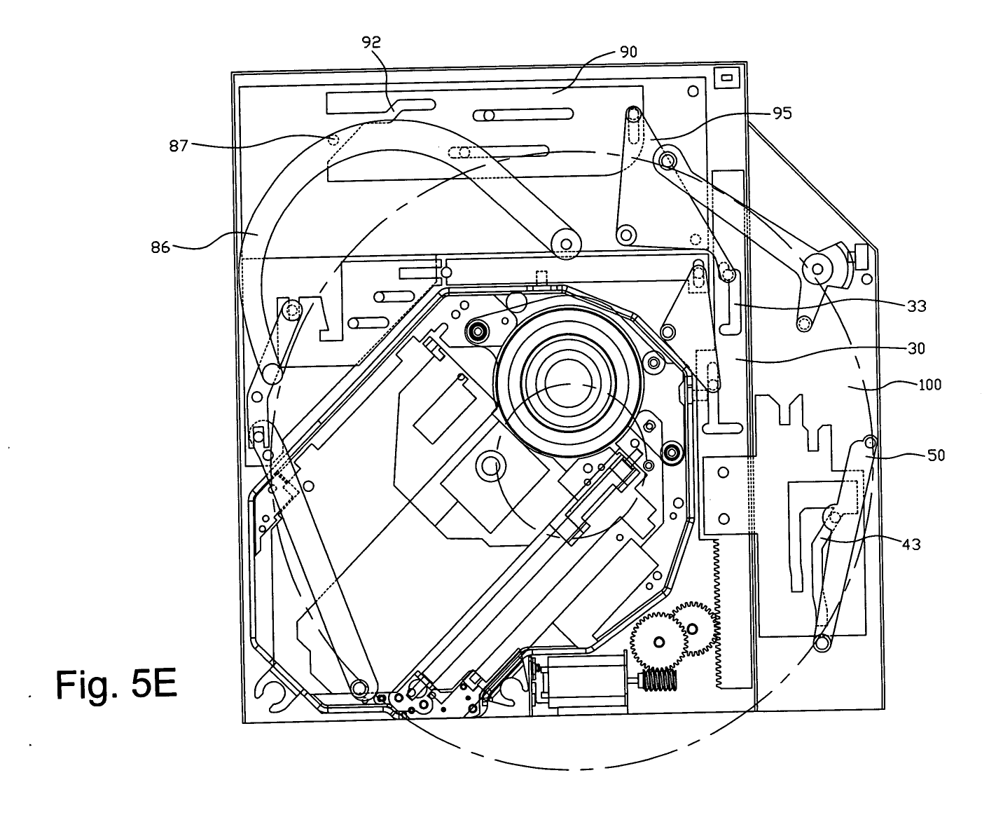

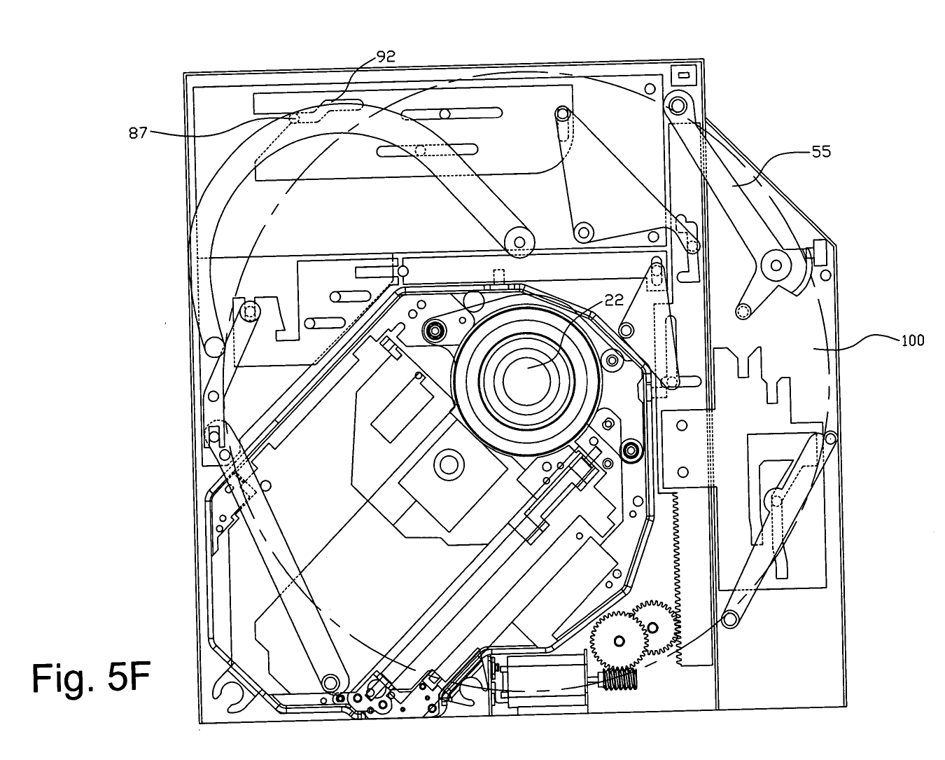

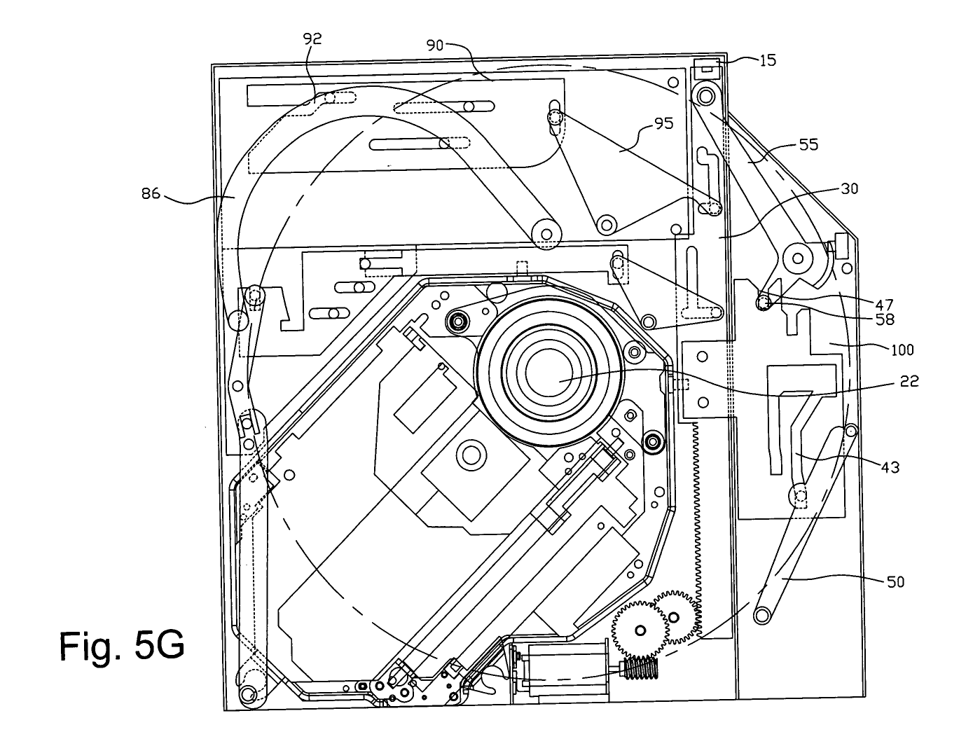

Refer to FIG. 5A, when the optical disk 100 with diameter of 12 cm is loaded into the optical disk drive, the optical disk 100 contacts the first link 71 and the push rod 50 first and then is pushed toward the push rod 50 by the first link 71. Later, the optical disk 100 is still pushed and then drives the first link 71 to rotate so as to make the fixing board 80 move leftward, as shown in FIG. 5B. Thus the guiding post 87 of the guiding arm 86 moves out of the lock plate 81. Refer to FIG. 5C, the optical disk 100 keeps moving and pushes the guiding arm 86 to rotate toward the stop plate 90. As shown in FIG. 5D, the optical disk 100 then pushes the pressed rod 55 to rotate so that the starting block 59 on the pressed rod 55 contacts the starting switch 14 to activate the motor 28 and thus the sliding member 30 moves upwards. The sliding post 52 of the push rod 50 slides into the first locating slot 43 of the sliding plate 40.

Refer to FIG. 5E, during the moving upwards process of the sliding member 30, the first locating slot 43 guides the push rod 50 to push the optical disk 100 entering the disk drive. The optical disk 100 keeps pushing the guiding arm 86 to rotate so as to make the guiding post 87 slide into the stop slot 92 of the stop plate 90. While the second ejector plate 95 is guided by the second sliding slot 33 of the sliding member 30 to push the stop plate 90. Then, as shown in FIG. 5F, by the guiding post 87 slides inside the stop slot 92, the guiding arm 86 is moved and positioned and the push rod 50 pushes the optical disk 100 to the position of rotation. Then the positioned disk 100 is set on the turn table 22.

At last, refer to FIG. 5G, in order to prevent the optical disk 100 being scratched by the turn table 22 during the rotation process, after the optical disk 100 arriving the position of rotation, the sliding member 300 keeps moving until it reaches the stop switch 15. Then the second ejector plate 95 pushes the stop plate 90 so as to make the stop slot 92 drag the guiding arm 86 to leave the optical disk 100 without contacting. While the positioning post 58 of the pressed rod 55 inserts in the third locating slot 47 so that the third locating slot 47 guides the pressed rod 55 to leave the optical disk 100. And the push rod 50 is guided by the first locating slot 43 for leaving the optical disk 100.

In summary, a positioning mechanism of a slot-in optical disk drive in accordance with the present invention can retrieve data from optical disks with diameters of 12 cm or 8 cm. When the optical disk is loaded into the disk drive, the sliding member 30 moves and the push rod 50 is guided by the first locating slot 43 or the second locating slot 45 of the sliding plate 40 so as to push the optical disk to the position of rotation. The central hole of the optical disk corresponds to the turn table 22 for being set on the turn table 22 and rotated to retrieve the data therein.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A positioning mechanism of a slot-in optical disk drive comprising:
a base chassis;
a sliding member disposed on the base chassis and capable of moving upwards and downwards;
a driving mechanism arranged on the base chassis for driving the sliding member to move;
a sliding plate disposed on the lower part of the sliding member and having a first locating slot and a second locating slot that connect with each other; and
a push rod arranged on the base chassis with a sliding post inserting through the first locating slot and the second locating slot; when the sliding plate moves along with the movement of the sliding member, the push rod is moved by an optical disk entering the disk drive; optical disks with different diameters push the push rod to rotate at different angles so that the sliding post slides inside the first locating slot or the second locating slot and then the push rod drives optical disks with different diameters into the position of rotation.

2. The device according to claim 1, wherein a gear rack is disposed on lateral side of the bottom of the sliding member and the driving mechanism having a motor and a gear set; by the gear set matching with the gear rack, the motor drives the gear set so as to make the sliding member move.

3. The device according to claim 1, wherein a pressed rod is disposed on the base chassis, over the top of the sliding plate and a third locating slot as well as a fourth locating slot is arranged on upper part of the sliding plate; while the push rod pushes the optical disk, the optical disk pushes the pressed rod to rotate and angle of rotation varies according to the size of the optical disk; when the push rod pushes the optical disk to the position of rotation, a positioning post arranged on one end of the pressed rod is mounted on the third locating slot or the fourth locating slot so as to guide the pressed rod leaving the optical disk without contact.

4. The device according to claim 3, wherein the pressed rod is hooked with an elastic component that is disposed on the base chassis.

5. The device according to claim 1, wherein a pressed rod is disposed on the base chassis, over the top of the sliding plate and when the optical disk enters the disk drive, the optical disk pushes the pressed rod to rotate so as to contact a starting switch for activating the driving mechanism.

6. The device according to claim 1, wherein the push rod is hooked with an elastic component that is disposed on the base chassis.

7. The device according to claim 1, wherein the sliding member further having a first sliding slot; one end of a first ejector plate on the base chassis inserts into the first sliding slot while the other end of the first ejector plate inserts into a transverse-moving member arranged on the base chassis, placed at the lateral side of the top of the sliding member; a lift slot is disposed on one lateral side of the sliding member and the transverse-moving member respectively for being inserted by a lift arm on two sides of the front end of a traverse on the base chassis; when the sliding member moves upwards, the first sliding slot drives the first ejector plate to move and further pushes the transverse-moving member, thus the lift arms move by the guidance of the lift slot to drive the traverse moving upwards for setting the optical disk on a turn table of the transverse.

8. The device according to claim 1, wherein the base chassis further having a guiding mechanism located at the position corresponding to the sliding member; when the push rod drives the optical disk into the optical disk drive, one site of the optical contacts the guiding mechanism that guides the optical disk so that the push rod pushes the optical disk into the position of rotation.

9. The device according to claim 8, wherein the guiding mechanism having
a linkage mechanism disposed at the base chassis, corresponding to lateral side of the sliding member;
a fixing board arranged at the base chassis, corresponding to the top of the linkage mechanism that has one end mounted on the fixing board; and
a guiding arm disposed on the base chassis with a guiding post hooked with the fixing board for fixing the guiding arm;
wherein the guiding arm presses against one side of a small size disk when the small size disk enters the disk drive, the sliding post slides in the second locating slot and the push rod pushes the small size disk into the position of rotation; when a large size disk enters the disk drive, the disk pushes the linkage mechanism to drive the fixing board, thus the guiding post separates with the fixing board and the sliding post slides in the first locating slot so that the push rod pushes the large size disk into the position of rotation.

10. The device according to claim 9, wherein the linkage mechanism having a first link and a second link, both disposed on the base chassis while the first link is connected with one end of the second link and the other end of the second link is mounted at the fixing board.

11. The device according to claim 10, wherein the first link is hooked with an elastic component that is disposed on the base chassis.

12. The device according to claim 9, wherein a lock plate is arranged on the fixing board; one end of the linkage mechanism is mounted on the lock plate and the guiding post on the guiding arm hooks with the lock plate.

13. The device according to claim 9, wherein the guiding arm is hooked with an elastic component that is disposed on the base chassis.

14. The device according to claim 9, wherein a separative slot is arranged on the fixing board, corresponding to a separative post on the transverse-moving member that is disposed on the base chassis, corresponding to the lateral side of top of the sliding member; one end of a first ejector plate on the base chassis inserts into the transverse-moving member while the other end of the first ejector plate inserts into a first sliding slot on the sliding member; when the sliding member moves upwards, the first sliding slot drives the first ejector plate so as to make the transverse-moving member move towards the fixing board while the separative post slides in the separative slot to push the fixing board moving so that the guiding post on the guiding arm separates with the fixing board when the push rod pushes the optical disk into the position of rotation; thus the guiding arm leaves the small size optical disk.

15. The device according to claim 9, wherein a stop plate is arranged on the base chassis, corresponding to the top of the guiding arm; a stop slot is disposed on the stop plate and the guiding post on the guiding arm slides inside the stop slot when the push rod pushes the large size optical disk; thus the stop slot drives the guiding arm to leave the optical disk when the push rod pushes the optical disk to the position of rotation.

16. The device according to claim 15, wherein the stop plate is connected with one end of a second ejector plate while the other end of the second ejector plate inserts into a second sliding slot of the sliding member; when the sliding member moves, the second ejector plate is driven by the second sliding slot to push the stop plate; the second ejector plate is arranged on the base chassis.
